(19) United States
(12) Patent Application Publication
(10) Pub. No.: US 2014/0306661 A1
(43) Pub. Date: Oct. 16, 2014

(54) Convenient Docks for Directly Charging Handheld Electronic Devices

(71) Applicants: David Jack Rosenblum, Paramus, NJ (US); Ana Idaly Rosenblum, Paramus, NJ (US)

(72) Inventors: David Jack Rosenblum, Paramus, NJ (US); Ana Idaly Rosenblum, Paramus, NJ (US)

(21) Appl. No.: 14/249,343

(22) Filed: Apr. 9, 2014

Related U.S. Application Data
(60) Provisional application No. 61/813,627, filed on Apr. 18, 2013.
(60) Provisional application No. 61/810,700, filed on Apr. 10, 2013.

(51) Int. Cl. H02J 7/00; F21L 4/08

(52) U.S. Cl. CPC H02J 7/0044; F21L 4/08
USPC 320/114; 362/183

(57) ABSTRACT

Docks for directly charging portable electronic devices, without need for media content communication across the dock-based connection, may be implemented in manually accessible wall socket arrangements and convenient power strips. Accessories such as connector cables and plug-in docks are not required. Direct-charging docks recessed for accepting the base of a device such as a handheld electronic device may have, in the recess, a male connector for snug electrical engagement to the device. Other connectors for such devices are implemented without recessed device docks but are surrounded by a rim to prevent injury that might result from inadvertent contact with the connector.

### FIELD OF THE INVENTION

The present invention relates an electrical connector for electrically charging a device and, more particularly, to positioning of the connector with respect to surrounding structure.

### BACKGROUND OF THE INVENTION

Handheld and portable electronic devices often can operate on battery power, and generally have ports for charging off wall current. Some of the devices use the same or other ports for transfer of media content. One example is provided in U.S. Pat. No. 8,323,040 to Prest (hereinafter “the '040 patent”), the entire disclosure of which is incorporated herein by reference. Often, connection for charging is effected by means of a flexible connector cable, e.g., standard Universal Serial Bus (USB) cable, having at the distal end a male connector to a power source. A male connector is commonly referred to as a plug and has a solid pin for a center conductor. A female connector is commonly referred to as a jack and has a center conductor with a hole in it to accept the male pin. U.S. Patent Publication No. 2012/0292991 to Dodal et al. is directed to a flush wall-mount outlet configuration that includes built-in female USB connectors, but a standard USB cable is needed and may not always be available. The '040 patent bypasses the need for the cable by providing a docking station that directly connects to the handheld electronic device. The station provides the capability to adjust the angle of the docked device, for the best viewing angle. Other features of docking stations as described in pending U.S. Patent Publication No. 2004/0224638 entitled “Media Player System” by Fadell et al; U.S. Patent Publication No. 2007/0047198 entitled “Docking Station for Hand Held Electronic Devices” by Crooijmans et al.; and U.S. Patent Publication No. 2006/0250764 entitled “Universal Docking Station for Hand-Held Electronic Devices” by Howarth et al. (hereinafter ‘the 764 publication’”), which are herein incorporated by reference in their entirety. However, although the need for a cable is eliminated, the docking station is instead required.

U.S. Pat. No. 8,229,501 to Struthers et al. (hereinafter “the '501 patent”), which is incorporated herein by reference in its entirety, discloses a docking station built into the wall. The back of the interior wall of the dock has a protruding male data connector, a protruding male power connector and an adjoining electrical outlet. Manual user access into the dock for the outlet is somewhat restricted by the recessed nature of the dock. This would present even more of a problem if a handheld device is already docked, and especially if the docking station is designed for a thin form factor device such as the iPod Touch™.

### SUMMARY OF THE INVENTION

Electrical outlets in coffee houses are ubiquitous, but charging a handheld electronic device typically requires that you bring along your laptop for its USB port and/or a flexible charging cable and/or a portable electronic device dock such as those that can charge an iPod™ or iPhone™. At home or in the office, wall sockets and power strips do not conveniently or fully accommodate one's immediate need to charge such a portable device without resorting to always having available accessories such as cables and docking stations.

Accessories that plug into a wall outlet such as the charging station in U.S. Patent Publication No. 2012/0019208 to Clouser can be utilized for charging handheld electronic devices. However, the charging station must be kept in place or made readily available when needed, and the large form factor blocks any other wall outlets on the panel.

There is no provision for using existing public and private facilities without the need for accessories.

Nor is there a convenient, relatively accessory-free means for charging these devices from battery power when a mains power source is unavailable such as in a remote area or during a power outage. U.S. Patent Publication No. 2007/0285053 to Noguchi et al., the entire disclosure of which is incorporated herein by reference, discloses a battery-powered portable charger with a female USB port, but, again, a flexible cable for the handheld device is needed.

What is proposed herein is directed to addressing one or more of the above concerns.

In an aspect of what is proposed herein, a power-providing device includes an outer surface, electrical outlets that each are female with respect to a connecting direction normal to the surface, and at least one additional connector that is male with respect to a respective connecting direction normal to the surface. The surface serves as a housing with respective orifices for the outlets and the at least one additional connector. One or more of the additional connectors have a user interface end that is recessed from or flush with a top of either: a) a respective rim that protrudes from the surface and surrounds the connector in case the rim is implemented; or b) the surface in case the rim is not implemented.

In another aspect, a handheld electronic device is configured for docking with an electrical connector for charging the device. The handheld electronic device is configured for, responsive to a result of checking a user account, at least one of refraining from and halting the charging.

In a further aspect, a power strip includes a panel having a flat outer surface that supports user interfaces to respective electrical outlets. Each of the outlets is configured for multi-prong reception. The surface also supports a built-in connector configured for engagement with a connector of a portable electronic device. The connector is also configured for supplying, via the engagement, the device with power. The built-in connector is male with respect to a direction of joining the built-in connector to the connector of the device.

In an additional aspect, a power strip includes a panel having an outer surface with orifices for a respective first plurality of built-in connectors facing in a same direction and configured for electrical engagement with a second plurality of connectors of respective handheld electronic device. The first plurality is further configured for supplying, via the engagement, the devices with power. The built-in connectors are male with respect to a direction of joining the devices to the built-in connectors. The power strip also includes a cord having, at one end, a connector to a source of electrical power.

In a related aspect, a connection structure is configured for mounting in a wall of a building. The structure includes a first built-in connector configured for engagement with a second built-in connector of a portable electronic device. The first built-in connected is also configured for supplying, via the engagement, the device with power. The first connector is male with respect to a direction of joining the second connector to the first connector. The structure further includes, over or flush with the wall, an outer, covering plate with an orifice for the first built-in connector.

In a different aspect, a wall socket arrangement for mounting in a wall includes an electrical outlet. It also includes a first built-in connector configured for engagement with a second built-in connector of a portable electronic device and for supplying, via the engagement, the device with power. The first connector is male with respect to a direction of joining the second connector to the first connector. The arrangement further includes, over or flush with the wall, an outer, covering plate with respective orifices for the outlet and the first connector.

In what is also an aspect, a portable-device-charging panel includes a portable-device dock that includes a connector and that is configured for docking, and charging, via the connector. The connector is male with respect to a direction of the docking. The panel further includes, alongside the dock, outlets that are female with respect to a direction of joining to the outlets for charging. The outlets are disposed outwardly and without recession that would lessen user access in manually mating the outlets with respective male connectors. The panel is configured for the outlets, and the dock, facing in a common direction outward from the panel.

In yet another aspect, a device-charging assembly comprises a handheld electronic device that includes a built-in rigid connector for docking the device. The rigid connector is configured for charging the device from a docked state without the need for a flexible connector. The rigid connector is male with respect to a direction of the docking. The assembly also includes a panel comprising a portable-device dock that includes a receiving connector into which the rigid connector fits in the docking. The receiving connector is female with respect to a direction of the docking. The assembly further includes outlets that are female with respect to a direction of joining to the outlets for charging.

In one further aspect, a wall socket arrangement for mounting in a wall includes an electrical outlet; and a first built-in connector configured for electrical engagement with a second built-in connector of a portable electronic device and for supplying, via the engagement, the device with power. The first connector is male with respect to a direction of joining the second connector to the first connector. The wall arrangement is not configured for, via the first built-in connector, communicating media content.

In another version, a power strip comprises: a plurality of male connectors for respective handheld electronic devices; and a cable for plugging into a wall outlet.

In a different version, a flashlight includes an outer casing and, within the casing, a compartment for a battery, the flashlight further including, protruding from or recessed into the casing, either a female or male built-in connector for mating to a corresponding built-in connector of a handheld electronic device, for charging the device from the battery.

In one other version, a battery-powered dock for charging a handheld electronic device includes a battery, and a male connector for electrically engaging a female connector of the device. The dock is configured for charging the device via the connector using electricity from the battery.

The drawings are not drawn to scale, and reference numbers shown in some views are implied by default for the same or similar structure in other views.

### BRIEF DESCRIPTION OF THE DRAWINGS

FIGS. 1A and 1B are respectively front and side views of a power providing device, in accordance with the invention;

FIG. 1C is a depiction of docking a portable device, in accordance with the present invention;

FIG. 1D is a depiction of plugs for connection with a power providing device, in accordance with the present invention;

FIGS. 2A and 2B are respectively front and side views of another version of a power providing device, in accordance with the present invention;

FIGS. 3A and 3B are respectively front and side views of yet another version of a power providing device, in accordance with the present invention;

FIGS. 4A and 4B are respectively front and side views of still another version of a power providing device, in accordance with the present invention;

FIGS. 5A-5C depict further exemplary aspects of a power providing device, in accordance with the present invention;

FIG. 6 is a flow chart exemplary of a payment for charging method, in accordance with the present invention;

FIG. 7 depicts a flashlight for charging, in accordance with the present invention;

FIGS. 8A and 8B conceptually depict a charger built into a wall in accordance with the present invention;

FIG. 9 depicts what the user is no longer burdened with carrying, in accordance with the present invention; and

FIG. 10 depicts a simplification offered, in accordance with the present invention.

### DETAILED DESCRIPTION OF EMBODIMENTS

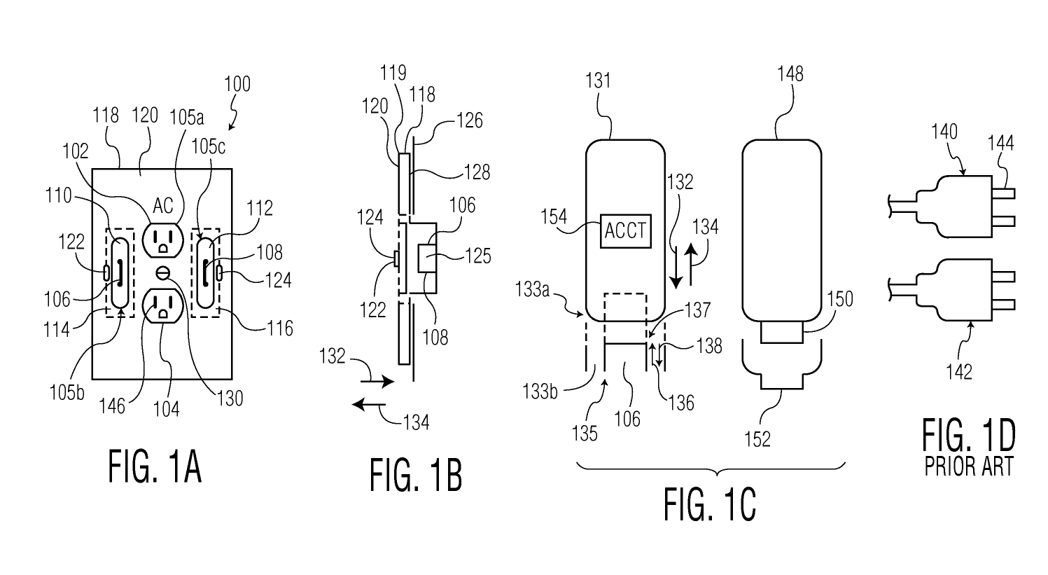

FIG. 1A shows, by illustrative and non-limitative example, a power-providing device (or portable-device-charging panel) 100. FIG. 1B is a side view. The device 100 includes two alternating current (AC) outlets 102, 104 having outlet user interfaces 105a; two handheld electronic device interfaces 105b, 105c comprising respective “additional” connectors (i.e., additional to those in the outlets) 106, 108 protruding from respective depressions or slots, or “portable-device docks”, 110, 112; two doors 114, 116 covering the depressions 110, 112 and their respective connectors 106, 108; and a covering plate 118 having an outer surface 119 (with a top 120) that includes the doors 114, 116. For manually opening and closing the doors 114, 116, the doors may have lips 122, 124, indentations (as discussed further below), or both. If the device 100 is installed in a wall 126, a periphery of a back surface 128 of the plate 118 may be disposed flush to the wall, by, for example, a retaining screw 130. The doors 114, 116, when closed, as shown in FIGS. 1A, 1B, are flush with the outer surface 119 of the plate 118, although, for example, the lips 122, 124 are seen as protruding in the side view FIG. 1B. As best seen in the side view FIG. 1B, the connectors 106, 108 protrude upward within the depressions 114, 116. However, the user-interface, or top, end 125 of the connector 106, 108 is recessed from the top 120 of the outer surface 119, for safety reasons. The user can swing open a door 114, 116 to expose the connector 106, 108, and manually force the female port end of a handheld electronic device 131 (as best seen in FIG. 1C) onto the connector, to charge the handheld electronic device such as a smartphone, personal digital assistant (PDA), handheld game console or portable media player. In this disclosure, a handheld electronic device is defined as an electronic device small and lightweight enough to be held in the user's hand or hands while the user operates the device. The connectors 106, 108 are male with respect to a connecting direction 132, 134 normal to the outer surface 119 of the plate 118. A connector, according to this disclosure, is defined as male, in the connecting direction, in its usual sense; except that, if the connector is recessed, its unshielded one or more prongs or pins are entirely peripherally surrounded in the recess by a gap into which the base of the docking device having the mating female connector fits upon mutual connection of the two connectors. The qualifier “in the connecting direction” is used to distinguish over the fact that, for example, a two-prong plug typically has holes near the distal ends of the prongs, those holes being configured for engagement by insertion in a direction normal to the connecting direction of the plug. The connector 106, 108, may be a connector having 30 lines or pins, namely a “30 pin connector”, such as those used for the iPod Touch™ or iPhone™. Pin 1 is shown in FIG. 1C, and denoted by reference number 135. Pin 30 is denoted by reference number 137. The pins 1 through 30 will be specialized, e.g., one serving as a ground and another having a potential of 5 volts. The depression 110, 112, can be dimensioned to laterally conform to an outer periphery of the portable electronic device which is configured for mating with the respective male connector 106, 108. In particular and as seen in FIG. 1C, the handheld electronic device 131 has a base 133a that, upon mutual connection of the male and female connectors, fits within a gap 133b. The gap 133b is within the portable-device dock 110 and peripherally surrounds the male connector 106. The fit between the gap 113b and the base 133a may or may not be snug enough to hold the handheld electronic device; whereas, the joining of male and female connectors creates a snug fit that holds a connector to its mate. The connectors 106, 108 have opposite orientations. Thus, for example, the handheld electronic device 131, such as an iPod Touch™ or iPhone™, may only face in one lateral direction (e.g., outward, to the left) if plugged into the left-hand connector 106, on the left-hand side of the plate 119; whereas, the device may only face rightward if plugged into the right-side connector 108. This makes it easier for the user to see from the screen of the handheld device whether or not the device is fully charged, or its charging status. In a coffee house, for example, often, a wall socket arrangement is centered at the table, with the arrangement being wall-mounted above the table or below. The above-described two-sided feature makes it easier for people sitting on either side of the table to monitor the charging. As an alternative to a wall panel, a lamp base can be the panel 100 containing, in addition to the electrical outlet 102, the at least one recessed device port and/or at least one rimmed device port.

In some embodiments, the connector 106 may be extendable 136 and retractable 138. An actuation button (not shown) may be provided for this purpose, as discussed in the '040 patent. The outlets 102, 104 are depicted as three-prong, but are more generally multi-prong, e.g., two-prong, for accommodating respective plugs (or “power-receiving elements”) 140, 142 (as shown in FIG. 1D). The plugs 140, 142 each have three prongs or pins 144 two of which are configured for engagement with power-providing receptors 146 of an AC outlet 104. In an alternative embodiment, discussed further below, a handheld electronic device 148 has a built-in male connector 150; in which case, a power-providing device has a built-in female connector 152 for mating.

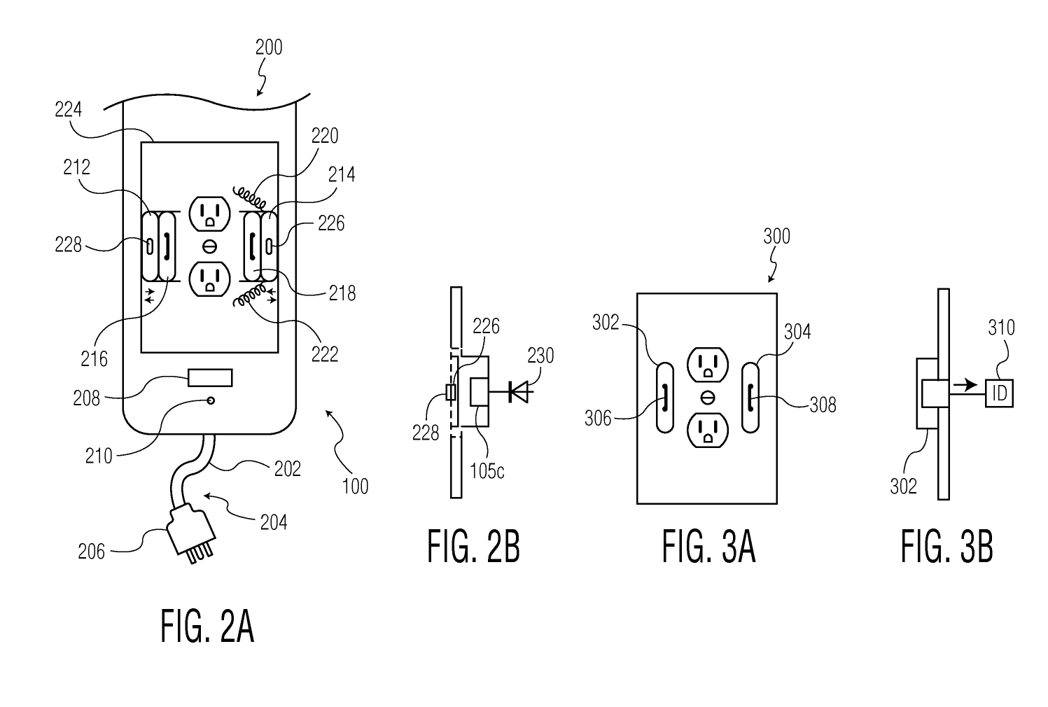

An exemplary embodiment according to FIG. 2A is realized as a power strip 200, with a cord or cable 202 and, at one end 204, a male connector or plug 206. The power strip 200 has an on/off rocker switch 208, and an on/off light-emitting diode (LED) indicator 210. Although, shown in the context of a power strip, the instant embodiment is implementable instead as wall socket arrangement, as will be clear from the explanation that follows. In fact, none of the variations in the figures to follow is restricted to a single mode of implementation, i.e., as a power strip (that connects to the wall directly or via a cord and plug) or as a wall socket configuration. In addition, although two connectors are shown in the drawings, a single connector may be implemented. Likewise, although two outlets are shown in a number of the drawings, any plurality of outlets may be implemented in the device 100. Also, all suitable features disclosed in the publications incorporated by reference may be implemented in the embodiments shown in this patent application. For example, the portable-device dock 110 may be made adjustable in size to accommodate handheld electronic device skins, via implementation of the adjustable members 28 discussed in the '764 publication. The adjustability also allows for the docking of different devices.

In FIG. 2A, doors 212, 214 slide open and close over the respective depressions 216, 218. A slid-open door 214 is biased toward closure by respective springs 220, 222 within or under a covering plate 224, the door 214 being within a track 224 of the plate. The user slides the door 214 open, and inserts the handheld device 131 which holds the door open. When the user is finished charging, he or she withdraws the device 131, allowing the door 214 to completely close. To open the door 214, an indentation 226 is provided; whereas, by further example, the other door 212 has a protruding lip 228. These structures are also seen in FIG. 2B. An alternative implementation of the spring-based shutter is found in U.S. Pat. No. 7,997,925 to Lam et al., column 5, lines 49-67 and FIGS. 2, 7 and 9, which disclosure is incorporated herein by reference. The shutter, in this embodiment, could for example slide back and forth vertically, instead of horizontally. As seen in FIG. 2B, the handheld electronic device interface 105c is powered by means of an AC to DC converter 230, in this case a semiconductor rectifier. The AC to DC converter is connected in parallel with supply lines to the AC outlets 102, 104, these all being energized from the mains electricity supply.

If, on the other hand, the male connector is not recessed, a user or passerby may inadvertently contact the connector and become cut or injured. Thus, as shown in FIG. 3A, a power-providing device 300 includes a rim or skirt 302, 304 (best seen in FIG. 3B) that surrounds a connector 306, 308. The rim 302, 304, like the depression 110, 112, can be dimensioned to laterally conform, snugly or less than snugly, to an outer periphery of the portable electronic device 131 which is configured for mating with the respective male connector 306, 308. The rim is hard or sufficiently inflexible so as to provide user protection against accidental contact with the connector 306, 308. It can be made of metal, plastic or any known and suitable material, and may be dielectric or other than a conductor of electricity.

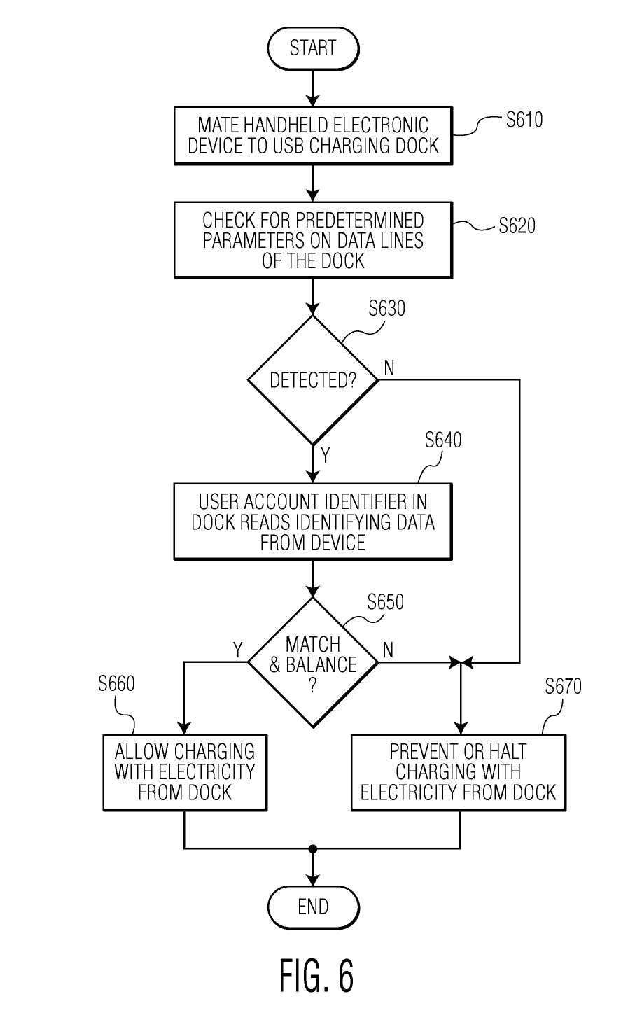

The power-providing device 100 may have a processor and memory serving as a computer readable medium (both not shown) for performing a customer account charging function. This feature, while generally not applicable to home use, may be implemented for coffee houses, public libraries, colleges, etc. The availability of the customer account charging function potentially increases the widespread adoption of such a device. The processor includes an account identifier 310 (shown in FIG. 3B), and an account balance 154 stored in memory and seen in FIG. 1C. More details on the customer account charging function are discussed below in connection with FIG. 6.

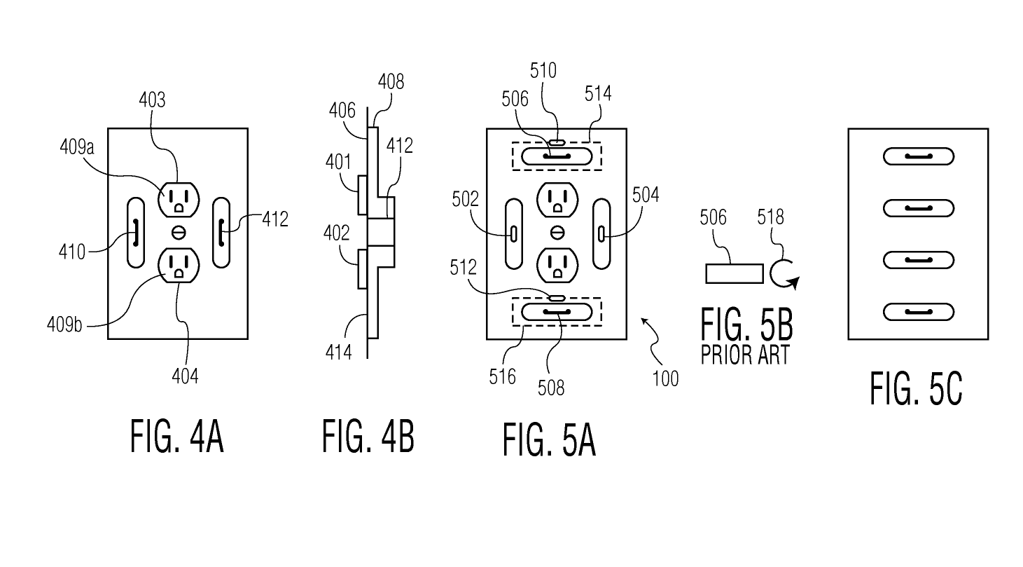

Tops 401, 402 of the electrical outlets 403, 404, as shown in FIG. 4, also may, instead of being flush with an outer surface 406 of a plate 408 as in FIGS. 3A and 3B, be respectively configured (e.g., slightly) elevated from the surface. The outlets 403, 404, therefore, are aligned with or protrude above the orifices 409a, 409b in the plate 408 for those outlets. Also seen in FIG. 4B by way of example, male connectors 410, 412 are implementable flush with the top 414 of the outer surface 406.

In a further variation, instead of male connectors, the additional receptors can be implemented as female connectors 502, 504. In FIG. 5A, the exemplary embodiment shows also male connectors 506, 508 in an operational position. The male connectors 506, 508 are pivotable down into this operational position. The user manually, by means of lips 510, 512, swings down respective doors 514, 516. Responsive to this, as shown by example for the top door 514, the priorly hidden connector 506 pivots 518 down into the operational position, as seen in FIG. 5B. Pivoting of the connectors is discussed in more detail in the '040 patent, e.g., FIGS. 2A and 2B and accompanying text in the detailed description. The phrase “responsive to” as used in the instant disclosure means that the action must result from the preceding event, i.e., the event to which it is responsive.

It is within the intended scope of what is proposed herein that the portable-device charging panel 100 need not include any outlets 102, 104 at all; instead, the panel may have only male and/or female connectors 502-508. The panel 100 may, for example and with reference to FIG. 5C, be implemented as a power strip with a cable for plugging into a wall outlet and contain only male connectors, recessed or not, and no outlets of its own. Or it may be implemented as a wall panel. The panel 100 can easily be installed alongside the power socket panel already in the wall, without having to modify the power socket panel. Likewise, the handheld electronic device power strip can be utilized side by side with power strips having only outlets. In either case, the panel can be configured with its handheld electronic device connectors all facing in the same direction for ease of use.

In operation, according to one version, and with reference to FIG. 6, the user manually moves the base 133a of the handheld electronic device 131 in a connecting direction 132 to dock the device to the portable-device charging panel 100 (step S610). Thus, the connector built into the handheld electronic device, i.e., a rigid male or female connector, directly engages physically, in a snug manner, and electrically the corresponding connector built into the panel 100. The handheld electronic device checks, via the connection, for one or more predetermined electrical parameters, e.g., 2.0 or 2.8 volts, on one or more respective data lines of the panel's connector (step S620). If detection is successful (step S630), charging can proceed provided a balance 154 exists in the user account. First, the user account identifier 310 in the panel 100 reads data from the handheld electronic device 131 to identify the user account (step S640). The data also includes the account balance. If the panel 100 verifies the validity of the user account and determines that an account balance sufficient for charging exists (step S650), the handheld electronic device is allowed to charge with electricity from the panel (step S660). Otherwise, if the panel 100 is unable to make the verification of validity or detects an insufficient account balance (step S650), charging with electricity is prevented or halted (step S670). Likewise, if a predetermined electrical parameter is not detected (step S630), charging with electricity is prevented or halted (step S670).

Alternatively, user account verification may be implemented in the handheld electronic device 131, with the panel 100 optionally having no processor or memory. Thus, the user account identifier 310 is in the handheld electronic device.

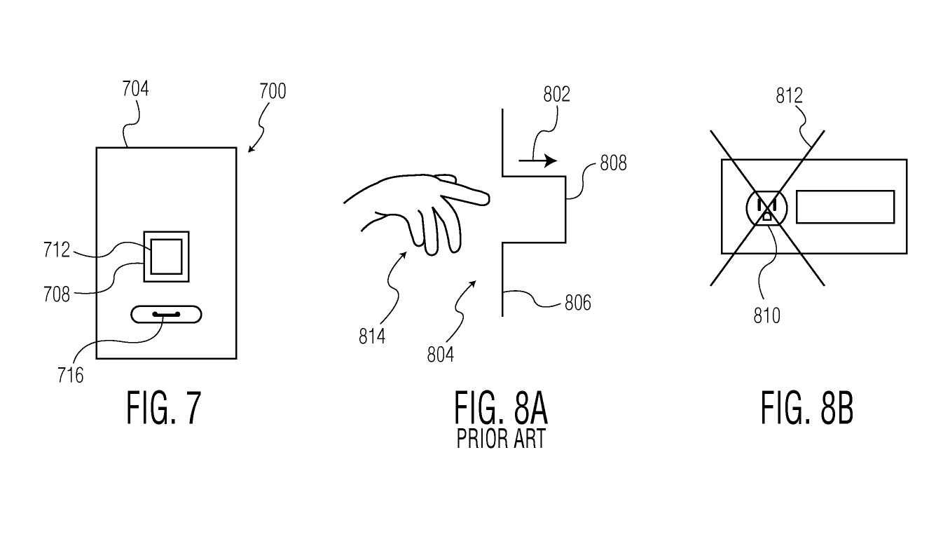

In a further embodiment, a flashlight 700, as seen in FIG. 7, includes an outer casing 704; within the casing, a compartment 708 for a battery 712; and, protruding from or recessed into said casing, either a female or male built-in connector 716 for mating to a corresponding built-in connector 150 of a handheld electronic device 148, for charging the device from the battery. As in all embodiments in this disclosure the connector, male or female, may be a 30 pin connector. The male or female connector matingly engages the corresponding connector directly to complete an electrical connection.

In one additional exemplary embodiment, a battery-powered dock for charging a handheld electronic device includes a battery and a male connector for electrically engaging a female connector of the device. The dock is configured for charging the device via the connector using electricity from the battery. The dock has an outer surface, with the connector being recessed, its top being flush with or below the outer surface. Other variations mentioned herein above are possible. For instance, the male connector male be configured to pivot downward into an operable position and to pivot upward into an inactive position flush with the outer surface.

An example of such a flashlight or battery-powered dock can be made based on U.S. Patent Publication No. 2007/0285053 to Noguchi et al. In particular and by way of example, the female USB output 44 in FIG. 1B of the publication is replaced with a connector configured for mating with a built-in connector of a handheld electronic device. The patent publication to Noguchi et al. is incorporated herein by reference in its entirety.

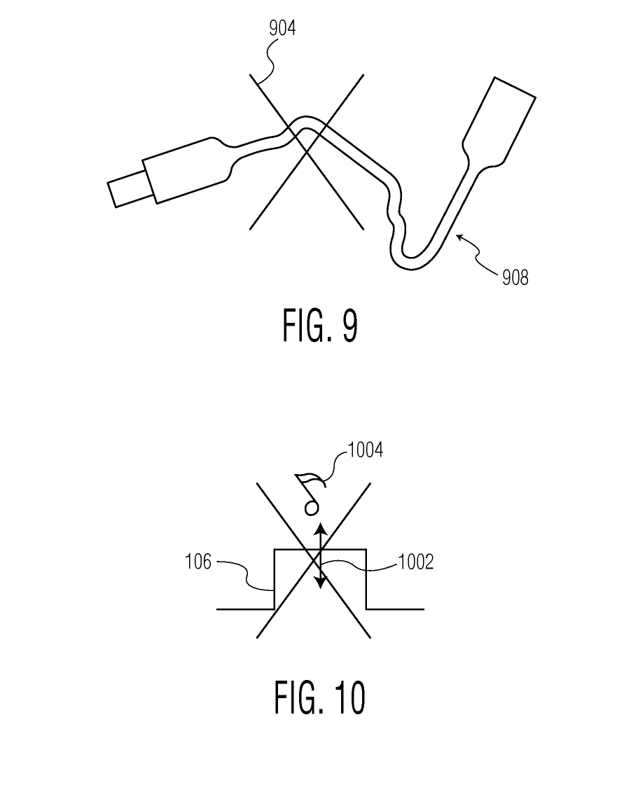

FIGS. 8-10 demonstrate conceptually some of the advantages of what is proposed herein. Recessing 802 a handheld electronic device dock 804 into the wall 806 of a building, as shown in FIG. 8A, and including in the back wall 808 of the recess an outlet 810 alongside the device connector, as seen in the side view, i.e., FIG. 8B, limits or lessens 812 manual access 814 by the user to the outlet. Advantageously, what is proposed herein affords easy and convenient user access. Also eliminated 904, as shown in FIG. 9, is the need for having available accessories such as a USB cable 908 or plug-in dock. Nor, as seen in FIG. 10, is the power-providing device required to communicate 102 media content 1004.

It should be noted that the above-mentioned embodiments illustrate rather than limit the invention, and that those skilled in the art will be able to design many alternative embodiments without departing from the scope of the appended claims. For example, a wall outlet arrangement or a power strip may be widened or lengthened to accommodate the handheld electronic device dock(s). Likewise, a power strip may be further widened for stability, to prevent tipping over due to docked device(s).

A computer program can be stored momentarily, temporarily or for a longer period of time on a suitable computer-readable medium, such as an optical storage medium or a solid-state medium. Such a medium is non-transitory only in the sense of not being a transitory, propagating signal, but includes other forms of computer-readable media such as register memory, processor cache, RAM and other volatile memory.

Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

What is claimed is:

1. A power-providing device comprising:
an outer surface;
a plurality of electrical outlets that each are female with respect to a connecting direction normal to said surface; and
at least one additional connector that is male with respect to a respective connecting direction normal to said surface,
said surface serving as a housing with respective orifices for said plurality of outlets and the at least one additional connector,
one or more of said at least one additional connector having a user interface end that is recessed from or flush with a top of either: a) a respective rim that protrudes from said surface and surrounds said connector in case said rim is implemented; or b) said surface in case said rim is not implemented.

2. The device of claim 1, for at least one from among said one or more additional connectors, respectively the rim in case it is implemented, or a portion of said device surrounding said one additional connector in case said rim is not implemented being dimensioned to laterally conform to an outer periphery of a portable electronic device configured for mating with the respective male connector.

3. The device of claim 1, implemented with feature b).

4. The device of claim 3, said surface comprising a respective door for a connector from among said at least one of said one or more additional connectors.

5. The device of claim 4, one or more of the doors each having, for correspondingly either sliding open or swinging open the door in providing access to the additional connector, an a) protruding lip; b) indentation; or c) both.

6. The device of claim 5, configured for providing a spring-based bias against said sliding open or swinging open such that the removing causes said respective door to close.

7. The device of claim 5, said respective door being, except for said lip, indentation or both, flush with said surface.

8. The device of claim 4, said door covering its connector.

9. A wall of a building, said wall comprising the device of claim 1, said device configured for serving as an arrangement of wall sockets.

10. The wall of claim 9, said device comprising a mounting plate having said surface, said plate mounted onto said wall.

11. The wall of claim 10, said plate having a back surface configured for being mounted flush to said wall.

12. The device of claim 1, an outlet from among said plurality being configured for providing alternating current (AC).

13. The device of claim 1, configured as a power strip.

14. The device of claim 1, said surface being flat.

15. The device of claim 14, wherein from among said at least one additional connector, two are on opposite sides of said surface.

16. The device of claim 15, the male connectors of said two having opposite orientations, said orientations being rotational around an axis that is disposed in said respective connecting direction.

17. The device of claim 1, at least one of said outlets being a multi-prong electrical outlet.

18. The device of claim 1, said one or more of said at least one additional connector having said respective rim.

19. The device of claim 18, each of said one or more having its respective one of the at least one rim.

20. The device of claim 18, said rim being hard, but not a conductor of electricity.

21. The device of claim 1, tops of said outlets being respectively configured flush with or elevated from said top of said surface.

22. The device of claim 1, said surface being an outer surface of a mounting plate with said orifices.

23. The device of claim 1, connecting to the plural outlets in said connecting direction being by removable physical attachment.

24. The device of claim 1, at least one of said one or more additional connectors being extendable and retractable.

25. The device of claim 24, further configured such that the extending does not extend beyond said top of either said rim in case said rim is implemented or said surface in case said rim is not implemented.

26. The device of claim 1, the male connector being built into said device and configured for mating, as a male connector, directly with a built-in connector of a handheld electronic device.

27. The device of claim 1, configured for energizing one or more of said at least one additional connector.

28. The device of claim 1, one or more of said at least one additional connector being a 30 pin connector.

29. The device of claim 1, further comprising an alternating current to direct current (AC to DC) converter for supplying one or more of said at least one additional connector with electrical current.

30. The device of claim 1, said at least one additional connector being divided among interfaces for respective one-to-one electrical engagement with handheld electronic devices, said orifices being apportioned one-to-one among said interfaces.

31. The device of claim 1, configured for, via a connector, from among said at least one additional connector, that is in electrical contact with a handheld electronic device, reading data from said handheld electronic device and for identifying, from the read data, a user account associated with said handheld electronic device.

32. The device of claim 31, further configured for charging said user account responsive to said identifying, provided an account balance criterion is met.

33. The device of claim 1, configured for, via one or more of said at least one additional connector in electrical contact with a handheld electronic device, supplying a predetermined data parameter indicative of an electrical charging function.

34. A handheld electronic device configured for docking with the device of claim 1 via a connector from among said at least one additional connector and for, automatically and without need for user intervention, checking user account information.

35. The handheld electronic device of claim 34, configured for allowing charging, via said connector to which said device is docked, responsive to a result of said checking.

36. A handheld electronic device configured for docking with an electrical connector for charging said device, said handheld electronic device being configured for, responsive to a result of checking a user account, at least one of refraining from and halting said charging.

37. The handheld electronic device of claim 36, configured for said checking.

38. The handheld electronic device of claim 36, said checking being performed, automatically and without need for user intervention, after said docking.

39. The handheld electronic device of claim 38, the responsiveness occurring in real time.

40. The handheld electronic device of claim 36, configured for allowing said charging depending on said result.

41. The handheld electronic device of claim 40, configured for said allowing occurring in real time response to said checking.

42. The handheld electronic device of claim 36, configured for said refraining.

43. The handheld electronic device of claim 36, configured for said halting.

44. A power strip comprising: a panel having a flat outer surface that supports user interfaces to a respective plurality of electrical outlets that are each configured for multi-prong reception, said surface also supporting a built-in connector configured for engagement with a connector of a portable electronic device and for supplying, via said engagement, said device with power, said built-in connector being male with respect to a direction of joining said built-in connector to said connector of said device.

45. The power strip of claim 44, further comprising a cord having, at one end, a connector to a source of electrical power.

46. The power strip of claim 44, configured for charging said device via said connector to said source.

47. The power strip of claim 44, said built-in connector being a 30 pin connector.

48. The power strip of claim 44, further comprising an alternating current to direct current (AC to DC) converter for supplying said built-in connector with electrical current.

49. The power strip of claim 44, further comprising:
a handheld electronic device interface configured for electrical engagement with a handheld electronic device which is said portable electronic device, said handheld electronic device interface comprising said built-in connector, said surface having orifices, from among said orifices there being respective orifices for said user interfaces and said handheld electronic device interface.

50. The power strip of claim 44, configured for, via said built-in connector in electrical contact with a handheld electronic device which is said portable electronic device, reading data from said handheld electronic device and for identifying, from the read data, a user account associated with said handheld electronic device.

51. The power strip of claim 50, further configured for charging said user account responsive to said identifying, provided an account balance criterion is met.

52. The power strip of claim 44, configured for, via said built-in connector in electrical contact with a handheld electronic device which is said portable electronic device, supplying a predetermined data parameter indicative of an electrical charging function.

53. A handheld electronic device configured for, as said portable electronic device of claim 44, docking with the power strip via said built-in connector and for, after said docking, checking user account information.

54. The handheld electronic device of claim 53, configured for allowing charging, via said connector to which said device is docked, responsive to a result of said checking.

55. A power strip comprising:
a panel having an outer surface with orifices for a respective first plurality of built-in connectors facing in a same direction and configured for electrical engagement with a second plurality of connectors of respective handheld electronic devices and for supplying, via said engagement, said devices with power, said built-in connectors being male with respect to a direction of joining said devices to said built-in connectors; and
a cord having, at one end, a connector to a source of electrical power.

56. The power strip of claim 55, a connector from among said plurality of built-in connectors being a 30 pin connector.

57. A connection structure configured for mounting in a wall of a building, said structure comprising:
a first built-in connector configured for engagement with a second built-in connector of a portable electronic device and for supplying, via said engagement, said device with power, said first connector being male with respect to a direction of joining said second connector to said first connector; and
over or flush with said wall, an outer, covering plate with an orifice for said first built-in connector.

58. The connection structure of claim 57, said first built-in connector being a 30 pin connector.

59. A wall socket arrangement for mounting in a wall, said arrangement comprising:
an electrical outlet;
a first built-in connector configured for engagement with a second built-in connector of a portable electronic device and for supplying, via said engagement, said device with power, said first connector being male with respect to a direction of joining said second connector to said first connector; and,
over or flush with said wall, an outer, covering plate with respective orifices for said outlet and said first connector.

60. The arrangement of claim 59, further comprising another electrical outlet, said covering plate having another orifice for said another electrical outlet.

61. The arrangement of claim 59, further comprising:
a handheld electronic device interface configured for electrical engagement with a handheld electronic device, said handheld electronic device interface comprising said first built-in connector, the orifices being respective orifices for said outlet and said handheld electronic device interface.

62. The arrangement of claim 59, said outlet configured for receiving, for charging, a multi-prong plug.

63. The arrangement of claim 59, configured such that said built-in connector is pivotable into and out of a state that enables said engagement.

64. The arrangement of claim 63, configured such that the pivoting into said state entails pivoting downward.

65. The arrangement of claim 59, wherein said outlet is an AC outlet.

66. The arrangement of claim 59, said first built-in connector being a 30 pin connector.

67. The arrangement of claim 59, further comprising an alternating current to direct current (AC to DC) converter for supplying said first built-in connector with electrical current.

68. The arrangement of claim 59, configured for, via said first built-in connector in electrical contact with a handheld electronic device, reading data from said handheld electronic device and for identifying, from the read data, a user account associated with said handheld electronic device.

69. The arrangement of claim 68, further configured for charging said user account for said electrical contact.

70. The arrangement of claim 69, further configured for said charging responsive to said identifying, provided an account balance criterion is met.

71. The arrangement of claim 59, configured for, via said first built-in connector in electrical contact with a handheld electronic device, supplying a predetermined data parameter indicative of an electrical charging function.

72. A portable-device-charging panel comprising:
a portable-device dock that includes a connector and that is configured for docking, and charging, via said connector, said connector being male with respect to a direction of said docking; and,
alongside said dock, a plurality of outlets that are female with respect to a direction of joining to said outlets for charging, the plural outlets being disposed outwardly and without recession that would lessen user access in manually mating said outlets with respective male connectors,
said panel configured for said outlets, and said dock, facing in a common direction outward from said panel.

73. The panel of claim 72, said connector being implemented as a connector for a handheld electronic device.

74. The panel of claim 72, said connector comprising a five-volt pin.

75. The panel of claim 72, said dock being configured for docking a handheld electronic device.

76. A device-charging assemblage comprising the panel of claim 72, and further comprising a handheld electronic device docked to said dock.

77. The panel of claim 72, wherein one or more of the plural outlets are AC outlets.

78. The panel of claim 72, said connector being a 30 pin connector.

79. The panel of claim 72, further comprising an alternating current to direct current (AC to DC) converter for supplying said connector with electrical current.

80. The panel of claim 72, said dock comprising an interface configured for electrical engagement with a handheld electronic device, said interface comprising said connector, said panel having orifices, from among said orifices there being respective orifices for said outlets and said dock.

81. The panel of claim 72, configured for, via said connector in electrical contact with a handheld electronic device, reading data from said handheld electronic device and for identifying, from the read data, a user account associated with said handheld electronic device.

82. The panel of claim 81, further configured for charging said user account for said electrical contact.

83. The panel of claim 82, further configured for said charging responsive to said identifying, provided an account balance criterion is met.

84. The panel of claim 72, configured for, via said connector in electrical contact with a handheld electronic device, supplying a predetermined data parameter indicative of an electrical charging function.

85. A device-charging assembly comprising:
a handheld electronic device that includes a built-in rigid connector for docking said device, and for charging said device from a docked state without need for a flexible connector, said rigid connector being male with respect to a direction of said docking; and
a panel comprising:
a portable-device dock that includes a receiving connector into which said rigid connector fits in said docking, said receiving connector being female with respect to a direction of said docking; and
a plurality of outlets that are female with respect to a direction of joining to said outlets for charging.

86. The assembly of claim 85, the plural outlets being disposed alongside said dock, said panel configured for said outlets and said dock facing in a common direction outward from said panel.

87. The assembly of claim 85, said panel implemented as a power strip.

88. The assembly of claim 87, said power strip having a cord, said cord having, at one end, a male outlet-plug for receiving power.

89. The assembly of claim 85, wherein one or more of the plural outlets are AC outlets.

90. The assembly of claim 85, said rigid connector being a 30 pin connector.

91. The assembly of claim 85, further comprising an alternating current to direct current (AC to DC) converter for supplying said receiving connector with electrical current.

92. The assembly of claim 85, said dock comprising an interface configured for electrical engagement with said handheld electronic device, said interface comprising said receiving connector, said assembly further comprising orifices, from among said orifices there being respective orifices for said outlets and said dock.

93. The assembly of claim 85, configured for, via said receiving connector, reading data from said handheld electronic device and for identifying, from the read data, an account associated with said handheld electronic device.

94. The assembly of claim 85, further configured for charging a user account for electrical contact with said receiving connector.

95. A wall socket arrangement for mounting in a wall, said arrangement comprising:
an electrical outlet; and
a first built-in connector configured for electrical engagement with a second built-in connector of a portable electronic device and for supplying, via said engagement, said device with power, said first connector being male with respect to a direction of joining said second connector to said first connector,
said wall arrangement not being configured for, via said first built-in connector, communicating media content.

96. The arrangement of claim 95, configured for, via said first built-in connection, communicating a data signal.

97. The arrangement of claim 95, said first built-in connector being a 30 pin connector.

98. The arrangement of claim 95, wherein said outlet is an AC outlet.

99. The arrangement of claim 95, further comprising a covering plate with respective orifices for said outlet and said first built-in connector.

100. The arrangement of claim 95, further comprising an alternating current to direct current (AC to DC) converter for supplying said first built-in connector with electrical current.

101. The arrangement of claim 95, configured for, via said first built-in connector, reading data from a handheld electronic device and for identifying, from the read data, said handheld electronic device.

102. The arrangement of claim 95, further configured for charging a user account for electrical contact with said first built-in connector.

103. A power strip having a plurality of male connectors for respective handheld electronic devices and a cable for plugging into a wall outlet.

104. The power strip of claim 103, a connector from among the plural connectors being a 30 pin connector.

105. A flashlight comprising:
an outer casing;
within said casing, a compartment for a battery; and,
protruding from or recessed into said casing, either a female or male built-in connector for mating to a corresponding built-in connector of a handheld electronic device, for charging said device from said battery.

106. The flashlight of claim 105, said connector for mating with said corresponding connector being a 30 pin connector.

107. The flashlight of claim 105, configured for said male or female connector matingly engaging said corresponding connector directly to complete an electrical connection.

108. A battery-powered dock for charging a handheld electronic device, said dock comprising:
a battery; and
a male connector for electrically engaging a female connector of said device,
said dock configured for charging said device via said connector using electricity from said battery.

109. The dock of claim 108, said connector being a 30 pin connector.

110. The dock of claim 108, having an outer surface, said connector being recessed and having a top, said top being flush with or below said outer surface.
